(19) United States
(12) Patent Application Publication
(10) Pub. No.: US 2011/0011226 A1
(43) Pub. Date: Jan. 20, 2011

(54) METHOD FOR EXPOSING RESIN-COATED METAL PIPE

(75) Inventors: Tomohiro TSURUSAWA, Koga-shi (JP); Kiyoshi Kasuya, Koga-shi (JP); Yoshikazu Ohtsuka, Koga-shi (JP)

Correspondence Address: POSZ LAW GROUP, PLC, 12040 SOUTH LAKES DRIVE, SUITE 101, RESTON, VA, 20191, US

(73) Assignee: SANOH INDUSTRIAL CO., LTD., TOKYO (JP)

(21) Appl. No.: 12/771,416

(22) Filed: Apr. 30, 2010

(30) Foreign Application Priority Data
Jul. 15, 2009 (JP) 2009-166274

(51) Int. Cl. B26D 7/06

(52) U.S. Cl. 83/23

(57) ABSTRACT

A method of exposing a metal pipe that is resin-coated by which part of the resin coating layer can be easily removed to expose the metal pipe. Blade tips are advanced into a resin coating layer in a region of the circumferential surface of a pipe with a predetermined spacing in the longitudinal direction of the pipe, and circumferential notches are introduced into the circumferential surface of the resin coating layer by rotating blades with respect to the pipe. A blade tip is advanced into a resin coating layer between the two circumferential notches and by moving a blade in the longitudinal direction, a longitudinal notch is introduced into the circumferential surface of the resin coating layer. A force is caused to act upon an outer circumferential surface of the resin coating layer between the two circumferential notches in the direction opposite that of the longitudinal notch and the resin coating layer is peeled off, thereby exposing a portion of the metal pipe.

### BACKGROUND OF THE INVENTION

1. Field of the Invention

The present invention relates to a method for exposing a metal pipe that is resin-coated, and more particularly to a method for exposing a metal pipe by which a resin coating layer is removed in an intermediate portion of the resin-coated metal pipe and the metal pipe is exposed.

2. Description of Related Art

Resin-coated metal pipes in which a metal pipe is coated with a resin to protect the pipe from flying stones and the like have been used, for example, in automobiles. In a case in which the resin-coated metal pipe is used for a fuel pipe, when fuel flows inside the pipe, static electricity is generated by friction between the fuel and the inner surface of the pipe. This static electricity charges the inside of the pipe and where the voltage increases, an electrostatic discharge is generated and the pipe can be damaged.

Accordingly, active measures have been taken to neutralize static electricity accumulated in the pipes (for example, Japanese Patent Application Laid-Open No. 2003-206818 (see FIG. 2 and FIG. 3)).

In the fuel pipe disclosed in Japanese Patent Application Laid-Open No. 2003-206818, a resin coating layer of a resin-coated metal pipe is removed, the metal pipe is exposed, an electrically conductive rubber is coated on the exposed portion, a clamp is attached to the electrically conductive rubber, and the clamp is joined to a vehicle body, thereby allowing static electricity of the metal pipe to escape to the vehicle body.

As a method for removing part of the resin coating layer of the resin-coated metal pipe and exposing the metal pipe, Japanese Patent Application Laid-Open No. 2007-252837 discloses a method by which notches are introduced in the circumferential direction with an appropriate spacing, then a longitudinal notch is introduced between two circumferential notches, a finger is then inserted from the notched gap, and the resin coating layer is stripped by hand.

However, with the invention disclosed in Japanese Patent Application Laid-Open No. 2007-252837, the operation of stripping the resin coating layer by hand is troublesome and requires a certain time.

### SUMMARY OF THE INVENTION

Accordingly, it is an object of the present invention to provide a method for exposing a metal pipe in the resin-coated metal pipe by which the metal pipe can be exposed by rapidly removing part of the resin coating layer.

A method for exposing a metal pipe that is resin-coated according to a first aspect of the present invention includes: advancing blade tips into a resin coating layer in a region of a circumferential surface of the pipe with a predetermined spacing in a longitudinal direction of the pipe; introducing circumferential notches into the circumferential surface of the resin coating layer; advancing a blade tip into the resin coating layer between the two circumferential notches; introducing a longitudinal notch into the circumferential surface of the resin coating layer; applying a force upon an outer circumferential surface of the resin coating layer between the two circumferential notches in a direction opposite that of the longitudinal notch; and peeling off the resin coating layer, thereby exposing part of the metal pipe.

A method for exposing a metal pipe that is resin-coated according to a second aspect of the present invention includes: introducing: a circumferential notch into a circumferential surface of a resin coating layer; and moving the resin coating layer on one side from the circumferential notch in a longitudinal direction of the pipe, thereby exposing part of the metal pipe.

According to the first aspect of the present invention, the resin coating layer is peeled off by applying a force upon an outer circumferential surface of the resin coating layer between the two circumferential notches in the direction opposite that of the longitudinal notch. Therefore, the resin coating layer can be rapidly peeled off.

According to the second aspect of the present invention, part of the metal pipe is exposed by moving the resin coating layer in the longitudinal direction. Therefore, the metal pipe can be rapidly exposed.

### BRIEF DESCRIPTION OF THE DRAWINGS

FIG. 1 is a schematic drawing illustrating an embodiment of the method for exposing a metal pipe in the resin-coated metal pipe in accordance with the present invention;

FIG. 2 is a schematic drawing illustrating a cutter device and a stripping device that are used in the embodiment shown in FIG. 1;

FIG. 3 is a schematic drawing illustrating another embodiment of the method for exposing a metal pipe in the resin-coated metal pipe in accordance with the present invention; and

FIG. 4 is a schematic drawing illustrating a cutter device and a stripping device that are used in the embodiment shown in FIG. 3.

### DESCRIPTION OF THE PREFERRED EMBODIMENTS

Embodiments of the method for exposing a metal pipe in the resin-coed metal pipe in accordance with the present invention will be described below with reference to the appended drawings.

The resin-coated metal pipe (referred to herein as “pipe”) 1 shown in the figure is obtained by coating a resin coating layer 3 on a metal pipe 2. Such a pipe 1 can be used, for example, as a fuel pipe or a brake pipe for an automobile, and the resin coating layer 3 can be formed by extrusion molding or the like on the metal pipe 2.

A first method for stripping the resin coating layer 3 of the pipe 1 and exposing the metal pipe 2 is described below.

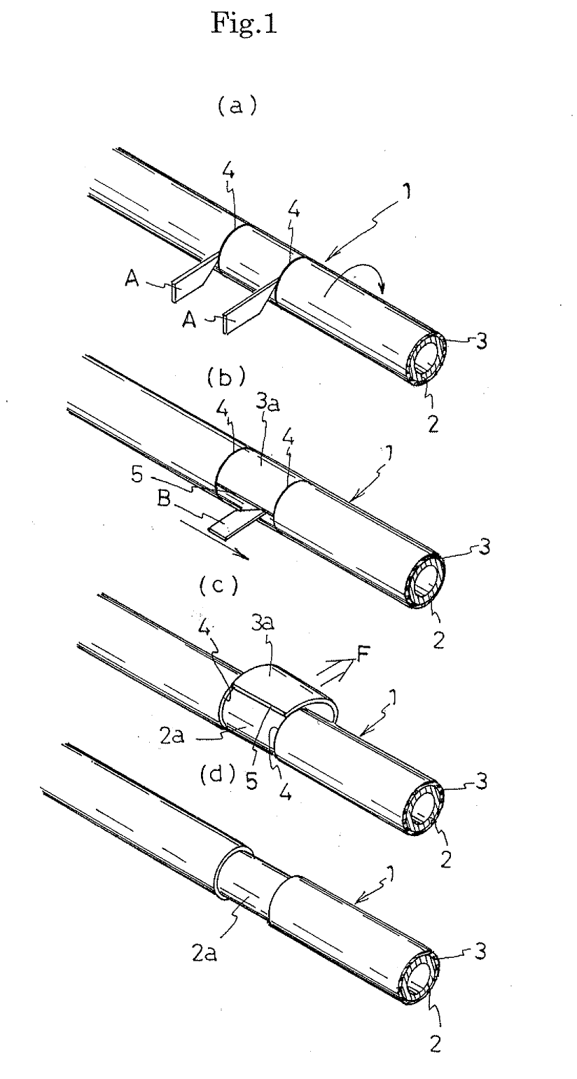

First, as shown in FIG. 1(a), circumferential notches 4, 4 are introduced with cutters A into the resin coating layer 3 at both ends of a region where the metal pipe 2 is to be exposed.

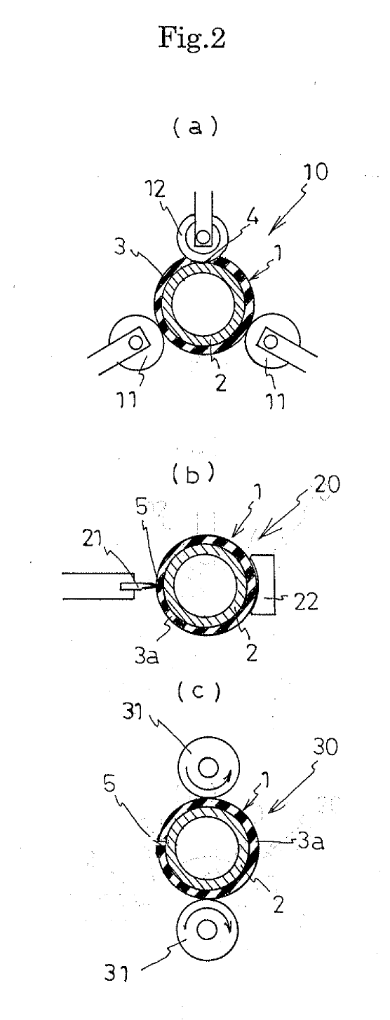

In the first process, for example, a cutter device 10, such as shown in FIG. 2(a) is used. In the cutter device 10, two support rollers 11, 11 and one disk cutter 12 are disposed with equal spacing (120-degree spacing) in the circumferential direction, so as to surround the pipe 1 and be movable in the radial direction of the pipe 1.

Where the support rollers 11, 11 and the disk cutter 12 are moved in the radial direction of the pipe 1, the pipe 1 is supported and the disk cutter 12 cuts in through a necessary distance into the resin coating layer 3. The support rollers 11, 11 and disk cutter 12 are then rotated with respect to the circumferential surface of the pipe 1 and the notch 4 is introduced in the resin coating layer 3.

The notch 4 can be also introduced by using as the cutter device 10 a device provided with another mechanism, for example, such that a blade is fixedly supported on the circumferential surface of the pipe 1 and the notch 4 is introduced by rotating the pipe 1.

Then, as shown in FIG. 1(b), a longitudinal notch 5 is introduced with a cutter B in the resin coating layer 3 between the notches 4, 4.

In the second process, for example, a cutter device 20 such as shown in FIG. 2(b) is used. The cutter device 20 is provided with a sheet-like blade 21 and a receiving member 22. The receiving member 22 abuts on the circumferential surface of the pipe 1 between the notches 4, 4, the blade 21 is brought into contact with the circumferential surface of the pipe 1 on the side opposite that of the receiving member 22, and a notch 5 is introduced by feeding the blade 21 through the thickness of the resin coating layer 3 towards the axial line of the pipe 1.

For example, a device in which a blade is disposed so that it can move in the longitudinal direction of the circumferential surface of the pipe 1 and the notch 5 is introduced by moving the blade in the longitudinal direction of the circumferential surface of the pipe 1 may be also used as the cutter device 20.

Then, as shown in FIG. 1(c), a force F is caused to act on the outer circumferential surface of the resin coating layer 3a between the notches 4, 4 in the direction opposite that of the notch 5, the resin coating layer 3a is peeled off, and the pipe 1 is obtained in which the metal pipe 2a is partially exposed as shown in FIG. 1(d).

In the third process, for example, a stripping device 30 such as shown in FIG. 2(c) is used. The stripping device 30 is provided with a pair of stripping rolls 31, 31 disposed so that they can move toward the axial center with respect to the circumferential surface of the pipe 1 and can be brought into contact with opposite sections of the circumferential surface of the pipe 1.

The stripping rollers 31, 31 are disposed in positions at an angle of 90 degrees in the circumferential direction with respect to the notch 5, that is, the stripping rollers 31, 31 are disposed in mutually opposite positions with respect to the axial center of the pipe 1, and the circumferential surface of the pipe 1 is clamped therebetween. The resin coating layer 3a is peeled off by rotating the stripping rollers 31, 31 in the respective directions from the notch 5 (directions shown by the arrows in FIG. 2(c)).

A device in which the resin coating layer 3a is peeled off by clamping the resin coating layer 3a of the pipe 1 between the distal ends of a pair of arms and pulling the arms in the direction from the notch 5 may be also used as the stripping device 30.

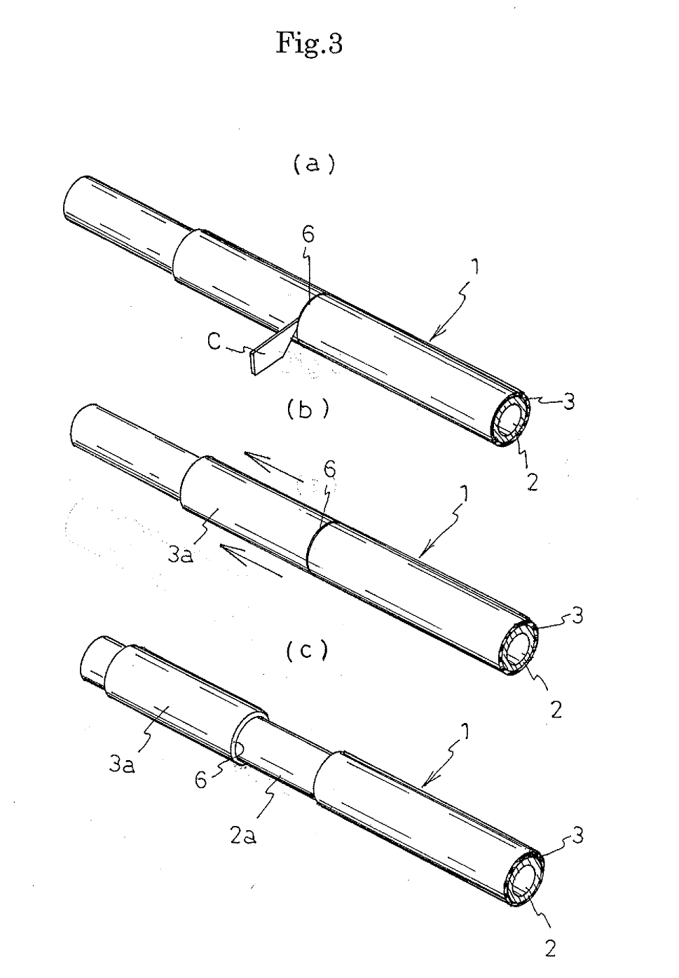

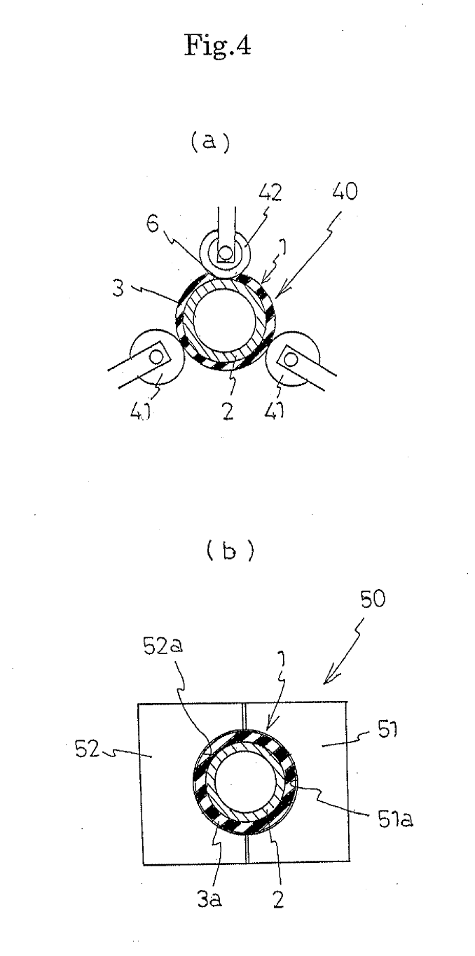

FIG. 3 and FIG. 4 illustrate the second method for stripping the resin coating layer 3 of the pipe 1 and exposing the metal pipe 2.

With this method, first, as shown in FIG. 3(a), a circumferential notch 6 is introduced with a cutter C into the resin coating layer 3 in a region where the metal pipe 2 is to be exposed.

In the first process, for example, a cutter device 40 such as shown in FIG. 4(a) is used. This cutter device 40 is similar to the cutter device 10 shown in FIG. 2(a) and includes two support rollers 41, 41 and one disk cutter 42 disposed with equal spacing (120-degree spacing) in the circumferential direction, so as to surround the pipe 1 and be movable in the radial direction of the pipe 1.

Where the support rollers 41, 41 and the disk cutter 42 are moved in the radial direction of the pipe 1, the pipe 1 is supported and the disk cutter 42 cuts in through a necessary distance into the resin coating layer 3. The support rollers 41, 41 and disk cutter 42 are then rotated with respect to the circumferential surface of the pipe 1 and a notch 6 is introduced in the resin coating layer 3.

The notch 6 can be also introduced by using as the cutter device 40 a device provided with another mechanism, for example, such that a blade is fixedly supported on the circumferential surface of the pipe 1 and the notch 6 is introduced by rotating the pipe 1.

Then, as shown in FIG. 3(b), the pipe 1 in which the metal pipe 2a is partially exposed is obtained, as shown in FIG. 3(c), by moving the resin coating layer 3a separated by the notch 6 in the direction shown by an arrow.

In the second process, for example, a moving device 50 such as shown in FIG. 4(b) is used. The moving device 50 is provided with moving block 51 that has a receiving surface 51a with an almost semicircular cross section and moves in the longitudinal direction of the pipe 1 and a pressure contact block 52 that has an abutment surface 52a with an almost semicircular cross section. The resin coating layer 3a of the pipe 1 is clamped between the receiving surface 51a of the moving block 51 and the abutment surface 52a of the pressure contact block 52, the pressure contact block 52 is fixed to the moving block 51, and the moving block 51 is moved in the longitudinal direction of the pipe 1. As a result, the clamped resin coating layer 3a is moved and the pipe 1 is obtained in which the metal pipe 2a is partially exposed.

Embodiments of the method for exposing a metal that is resin-coated in accordance with the present invention are described above, but the present invention is not limited to these embodiments and a variety of changes and modifications obviously can be made within the technical scope of the present invention.

What is claimed is:

1. A method for exposing a metal pipe that is resin-coated,
the method comprising: advancing blade tips into a resin coating layer in a region of a circumferential surface of the pipe with a predetermined spacing in a longitudinal direction of the pipe; introducing circumferential notches into the circumferential surface of the resin coating layer; advancing a blade tip into the resin coating layer between the two circumferential notches; introducing a longitudinal notch into the circumferential surface of the resin coating layer; applying a force upon an outer circumferential surface of the resin coating layer between the two circumferential notches in a direction opposite that of the longitudinal notch; and peeling off the resin coating layer, thereby exposing part of the metal pipe.

2. A method for exposing a metal pipe that is resin-coated,
the method comprising: introducing a circumferential notch into a circumferential surface of a resin coating layer; and moving the resin coating layer on one side from a circumferential notch in a longitudinal direction of the pipe, thereby exposing part of the metal pipe.
